(19) United States
(12) Patent Application Publication
(10) Pub. No.: US 2021/0154592 A1
(43) Pub. Date: May 27, 2021

(54) METHOD AND SYSTEM FOR DRYING MINE TAILINGS

(71) Applicant: CEDA Services and Projects LP, Calgary (CA)

(72) Inventors: Spencer Fried, Calgary (CA); Ian D. Gates, Calgary (CA); Jingyi Wang, Calgary (CA); Yi Su, Calgary (CA)

(21) Appl. No.: 17/046,814

(22) PCT Filed: Apr. 23, 2019
(86) PCT No.: PCT/CA2019/050501

§ 371 Date: Oct. 12, 2020

Related U.S. Application Data
(60) Provisional application No. 62/660,562, filed on Apr. 20, 2018.

(51) Int. Cl. B01D 1/20; B01D 1/18; B01D 5/00; B01D 3/10; C02F 1/12; C02F 11/13; C02F 11/14

(52) U.S. Cl. CPC B01D 1/20; B01D 1/18; B01D 5/006; C02F 2103/10; C02F 1/12; C02F 11/13; C02F 11/14; B01D 3/10

(57) ABSTRACT

A method and system to treat and dry fines tailings generated from mining operations, comprising spraying the tailings material into a vacuum chamber operated at less than atmospheric pressure to separate evaporated water from the residual solid materials.

### FIELD OF THE INVENTION

The present invention relates to treatment of tailings materials from mines.

### BACKGROUND OF THE INVENTION

Fines tailings from mining operations are a composite material comprising a mixture of water, clay, sand, and residual hydrocarbons.

In oil sands mining operations, tailings material is generated during the oil sands extraction process where the clay and other solids are separated from the oil sand to yield bitumen.

The tailings, in typical practice, are deposited into large ponds where the sand and larger particulates (>0.25 mm) settle to the bottom of the system whereas the next densest material, the fines tailings (referred to herein as tailings or tailings materials), accumulates in a middle layer above the sand layer and below a water-rich interval. The water, generally above the middle layer, can contain fine suspended particles that remain in suspension for extended time periods. The tailings materials that enter the tailings pond from the oil sands mining processing plant also contains oil. In oil sands mining operations, up to 1% of the material that is placed in the tailings pond is oil. Typically, this oil remains within the tailings materials in the pond and is not produced from the pond.

A key challenge faced by oil sands mining operations from an environmental stance is the accumulation of tailings ponds as they are large in size and have the potential for leaks of water (contained in the ponds) into the environment. Also, the fines can remain suspended for decades or longer thus preventing the separation of water from the tailings over practical time periods.

The intention of all oil sands mine operations is that the tailings ponds are ultimately returned to their original state (e.g., boreal forest) upon completion of the mining operation.

It is desired that the tailings are consolidated by having the water removed from the media. One challenge for treatment of tailings is that the porosity is relatively large and the pore space is saturated with water and a small amount of oil, but the permeability is very low as water binds to the clays through electrostatic and van der Waals forces and thus, water separation from the tailings material is difficult.

Given the nature of tailings with its fine clay particles and low permeability, the amount of time it will take for natural consolidation of tailings under gravity force is on the order of tens to hundreds to thousands of years depending on a variety of factors including the size of the clay particles. This means that practically, there is no present commercial solution for these tailings ponds to consolidate or dry the tailings material to enable the return of the land occupied by the tailings pond to its original state.

The drying of tailings, meaning the removal of at least a majority of the water in tailings, is understood to be a required step for reclamation of the tailings ponds. What is needed, therefore, is a process that yields a solid product at the end of processing in a time period which is several orders of magnitude shorter than existing methods for treating tailings (e.g., heating methods, centrifugation methods, etc.). Preferably, the tailings to be consolidated are mature fines tailings from oil sands operations, but it is desired to establish a process that can be used for any tailings.

### SUMMARY OF THE INVENTION

According to a first broad aspect of the present invention, there is provided a method for at least partially drying tailings materials from a mining operation, the tailings materials comprising water and solids, the method comprising the steps of:
a. generating droplets of the tailings materials;
b. introducing the droplets into a partial vacuum environment; and
c. allowing at least some of the water in the droplets to evaporate to produce a water vapour and a solids-dominant residual material.

In some exemplary embodiments of the present invention, the step of generating droplets is achieved by spraying. The spraying is preferably atomizing.

In some exemplary methods there is a step after step c. of extracting the water vapour from the partial vacuum environment and allowing the water vapour to condense into liquid water, which liquid water may be transported for re-use in the mining operation. The solids-dominant residual material may also be extracted from the partial vacuum environment.

In some exemplary embodiments at least one chemical additive is introduced to the tailings materials before the step of generating the droplets, which additive may be selected from the group consisting of gases, salt solutions, acids, bases, polymers and flocculants.

In some exemplary embodiments the methods include the step of heating the tailings materials before the step of generating the droplets. The partial vacuum environment may also or alternatively be heated.

Exemplary methods may further comprise transporting the tailings materials from a storage pond prior to generating the droplets. In addition or alternatively, exemplary methods may comprise obtaining the tailings materials directly from an extraction process.

In some exemplary embodiments, methods comprise the step after step c. of allowing the solids-dominant residual material to impact a surface to release additional water.

According to a second broad aspect of the present invention, there is provided a system for at least partially drying tailings materials from a mining operation, the tailings materials comprising water and solids, the system comprising:
a tailings materials source; and
a vacuum chamber comprising an inlet for receiving the tailings materials from the tailings materials source, the vacuum chamber configured to allow at least some of the water in the tailings materials to evaporate to produce a water vapour and a solids-dominant residual material;
the vacuum chamber further comprising a vapour outlet for allowing the water vapour to leave the vacuum chamber; and
the vacuum chamber further comprising a solids outlet for allowing the solids-dominant residual material to leave the vacuum chamber.

In some exemplary embodiments of this second aspect, systems further comprise a condenser in fluid communication with the vapour outlet for receiving the water vapour and condensing the water vapour into liquid water.

Exemplary systems may further comprise a chemical additives source and a chemical additives input line for introducing chemical additives into the tailings materials before the tailings materials enter the inlet of the vacuum chamber. Heat applicators may also be incorporated to heat the tailings materials before the tailings materials enter the inlet of the vacuum chamber. Gas injectors may be incorporated to inject gas into the tailings materials before the tailings materials enter the inlet of the vacuum chamber.

In some exemplary embodiments, the inlet comprises a nozzle configured to atomize the tailings materials to generate droplets.

In some exemplary systems, the vacuum chamber is a vacuum tower of a height sufficient to allow production of the water vapour and the solids-dominant residual material as the tailings materials pass downwardly through the vacuum tower.

The solids outlet is preferably in communication with a solids removal subsystem. The solids removal subsystem preferably comprises an open-close gate or a screw conveyor for transporting the solids-dominant residual material away from the vacuum chamber.

The present invention described herein through exemplary embodiments seek to accomplish drying or partial drying of tailings by using a vacuum process. Methods according to the present invention can be used to treat existing fluid fines tailings deposits or be a primary component of the initial oil recovery process. In some exemplary embodiments of the present invention, the tailings are sprayed within a vacuum chamber such that the water in the tailings, at its entry temperature or temperature of the vacuum chamber, evaporates at the vacuum pressure. The spray inside the vacuum chamber can yield tailings droplets with size ranging from a fraction of a millimeter to a few centimeters. After the tailings material is sprayed into the vacuum chamber, it falls under gravity to the base of the vacuum chamber. While falling to the base of the vacuum chamber, the water within the droplet starts to evaporate at its boiling temperature corresponding to the vacuum pressure.

For example, if the vacuum chamber is maintained at 10 kPa absolute pressure, the boiling point of the water is 45.8° C. This means that if the pressure in the vacuum chamber is 10 kPa and the wet tailings enters the unit at a temperature equal to or above the boiling point of 45.8° C., the water will rapidly boil off thus separating it from the solid tailings material. The water, in vapour form, can be taken from the vacuum unit as a stream that is then further condensed to liquid water at atmospheric pressure. [025] In another example, if the vacuum chamber is kept at 1 kPa absolute pressure, then the corresponding boiling point of the water is 6.97° C. This means that if the pressure of the vacuum chamber is 1 kPa and the wet tailings enters the unit at a temperature equal to or above 6.97° C., the water will rapidly boil off from the droplets therefore separating the water from the tailings material.

The vacuum chamber may be a vacuum tower or any other suitable pressure vessel or vessel that has an absolute pressure lower than 1 atmosphere, in the judgment of the skilled person.

The solid material that is collected at the base of the vacuum unit may be removed from the unit by using an open/close gate or a solid removal device such as a screw conveyor, but the skilled person would be aware of other mechanisms suitable for such purpose given the nature and configuration or design of the vacuum chamber.

If a vacuum tower is used, the tailings material may be sprayed into the unit near the top of the unit. The height of the tower should then be designed such that there is enough time for sufficient water to evaporate from the largest sprayed droplets.

If the droplet still comprises water when it reaches the bottom of the vacuum tower, the inertial impact of the spray droplet on the substrate automatically separates the water and compresses the tailings droplet into a flat and thin pancake which can facilitate further evaporation of water from the tailings material.

Prior to being sprayed into the vacuum unit, the tailings material may be mixed with additives that may help with drying and/or consolidating the tailings and rejecting water, and the skilled person would know of such additives and their effect and utility. These additives may, for example, be gases, salt solutions, acids or bases, polymers, and/or flocculants.

When sprayed into the vacuum chamber, the tailings material may be jetted through a nozzle in combination with a gas, which atomizes the tailings material into droplets, typically in diameter between 1 micron and 5 cm. Preferably, the droplets have a diameter between 0.5 mm and 5 cm. Most preferably, the droplets have a diameter between 0.5 mm and 2.5 cm. [032] Residual materials contained in the dewatered tailings are trapped within the dried tailings solids. This includes oil and additives that were added to the tailings material prior to spraying into the vacuum chamber.

Given the environmental challenges of tailings ponds faced by mine operators, there is an ongoing need for effective and economic processes to de-water and consolidate and dry tailings materials. The drying or partial drying of tailings as described herein with removal and collection of water enables a more rapid conversion of these tailings ponds to their original state in a practical time frame of a few years. Drying and consolidating the tailings to a particular strength is also required for reclamation. This is because soil, trees and plants may ultimately be placed on top of the reclaimed tailings layer, and thus the layer must comprise a certain strength so as to not fail mechanically.

An advantage of certain embodiments of the present invention is that the recovered water can be returned to the mining operation process or treated and sent back into a regional water source, thus allowing for significant cost and environmental benefits. For example, in current bitumen mining processes, significant amounts of water may be used when stripping oil from the oil sands. A plant operator ideally recovers a large portion of this process water back from the tailings ponds, however, there still may be a need for additional water for the mining process which is typically supplied from an external source such as a local river. The present invention may increase the direct recovery of water from the tailings material allowing operators to require less make-up water from external sources.

The vacuum drying process can be used to treat legacy tailings already contained in tailings storage or alternatively incorporate the vacuum drying tower directly into the primary separation process to directly dry the tailings and recover the process water.

Another advantage of some embodiments of the present invention lies in the use of vacuum to accelerate the drying of the tailings material.

Due to the use of a vacuum environment and the known fact that saturated steam/water boils at a temperature lower than that of atmospheric conditions (1 atmosphere pressure 101.325 kPa) when under vacuum conditions (pressure lower than 1 atmosphere pressure), the water in the tailings will evaporate, transforming from liquid phase to vapour phase, when introduced to the vacuum chamber.

In some exemplary methods according to the present invention, chemicals are added to the tailings material before it is injected into the vacuum chamber which enable further rejection of water from the tailings material. In these embodiments, in a first step, mixtures of metal halide (MXn) solutions, with and without an acid and/or base (to adjust pH as required), are added directly into the tailings prior to introducing the tailings to the vacuum chamber. For example, M may be aluminum, iron, sodium, potassium or copper, while X may be fluoride, chloride, bromide or iodide and n is the number of X atoms. An example is where M=aluminum, X=chlorine, and n=3 to form AlCb. The mixture may be injected and mixed directly into the tailings material within a pipe used for transporting the tailings to the vacuum chamber or within a vessel or static mixer upstream of the vacuum chamber.

In a second step, this mixture of the tailings material and chemicals is injected and sprayed into the vacuum chamber. The size of the droplets of tailings material emitted into the vacuum chamber can be controlled by selecting the appropriate nozzle, as would be within the knowledge of the skilled person.

The process described herein can be undertaken as an alternative to thin layer deposition or other known processes such as centrifugation, coagulation thickening or water capping processes. One advantage of embodiments of the present invention is that the equipment required may be relatively simple compared to other solutions known in the industry.

In some exemplary methods according to the present invention, a cellulose nanocrystal suspension can be added to the tailings material before employing the spray device. The cellulose nanocrystal can help to consolidate the tailings material. The mixture of the nanocrystal suspension and tailings material is then sprayed into the vacuum chamber.

In some exemplary methods according to the present invention, a polymer and/or flocculent can be added to the tailings material before the mixture enters the vacuum chamber. The polymer allows for more rapid consolidation of the tailings material by flocculating the tailings solids into a more cohesive and consolidated solid mass. [043] The injected gas may consist of air, carbon dioxide, nitrogen, natural gas, or mixtures thereof. The gas can be added to the tailings material directly or used at the spray nozzle within the vacuum chamber to help atomize and disperse the tailings material into droplets.

Embodiments according to the present invention may comprise at least some of the following features:
a. Ejection of tailings materials through a spray device to yield droplets of tailings material that have sizes ranging from microns to millimeters to several centimeters into a vacuum chamber where the pressure is lower than 1 atmosphere.
b. In some embodiments, the vacuum chamber has a sufficient height or volume to allow for evaporation of all of nearly all of the water from the droplets to realize a dry or partially dry tailings solid. The tailings solid is collected at the base of the vacuum chamber and the evaporated water and other volatile components are the tailings material is diverted from the vacuum chamber and is collected are processed to a liquid phase.
c. The exemplary methods may be conducted continuously or in a batch mode depending on the volume of tailings being handled.
d. A primary solution may be prepared on the surface and added to the tailings material prior to introduction of the material into the vacuum chamber. Preferably, the solution is a solution of FeCb and AlCb with 10% concentration. The solution of these metal halides can improve the ability of the tailings material to coagulate yielding a more consolidated tailings material. The mixture of tailings material and the solution can be stored in a tank for a period of time prior to spraying. In other embodiments, other materials such as polymers or cellulose nanocrystal or flocculants can be added to the tailings material.
e. Gas (preferably nitrogen, carbon dioxide, air or a mixture of these components) can be used with the spray device to aid in the break-up of the tailings flow to achieve droplets of a desired size.

In some exemplary methods of the present invention, gas is not used to help disperse the droplets in the spray device.

Methods according to the present invention can also be used with non-oil sands tailings ponds such as mineral mining tailings ponds.

Prior to the vacuum chamber, the tailings material can be stored in a tank and by using gas flotation, any oil in the tailings material can be separated. Also, through gravity segregation, larger tailings material particles can be separated from the tailings material that is subsequently sprayed.

In some embodiments, heat may be supplied to the vacuum chamber to achieve a targeted temperature within the chamber.

In some exemplary embodiments of the first aspect, more than one spray nozzle is used within the vacuum chamber.

A vacuum device may be employed for creating a pressure lower than atmospheric pressure within the vacuum chamber. Such devices may include, but are not limited to, vacuum pumps, Venturi devices, suction pumps, momentum transfer pumps, molecular pumps, screw pumps, rotary vane pumps, scroll pumps, steam ejectors, and cryopumps.

The collection of solids may be achieved by using known devices for moving solids such as, but not limited to, screw conveyors, augers and sealed conveyor belts. In some exemplary embodiments, a gated drop system may be employed where two gates are used to seal the vacuum chamber. In operation, the first gate opens and allows solid to drop into a lower chamber and then the first gate closes. Next, a lower second gate opens and allows the solid to drop from the lower chamber to a collection system exposed to atmosphere. The second lower gate then closes. The solids may be ultimately dropped onto a moving conveyor system to enable continuous operation. Embodiments that are arranged with this two gate system are configured to maintain a vacuum within the vacuum chamber.

The vacuum chamber apparatus can also be used within an existing tailings processing plant. For example, it can be used after the primary and/or secondary separators of an oil sands mining bitumen/tailings separation plant. In some cases, it could be used downstream of a naphtha recovery unit which is itself downstream of the froth treatment plant (primary and secondary separators). In other cases, it could be used downstream of the primary separation cell in which bitumen is separated from the oil sands ore.

A detailed description of exemplary embodiments of the present invention is given in the following. It is to be understood, however, that the invention is not to be construed as being limited to these embodiments. The exemplary embodiments are directed to particular applications of the present invention, while it will be clear to those skilled in the art that the present invention has applicability beyond the exemplary embodiments set forth herein.

### BRIEF DESCRIPTION OF THE DRAWINGS

In the accompanying drawings, which illustrate exemplary embodiments of the present invention:

FIG. 1 is simplified schematic of a first embodiment according to the present invention, wherein tailings material is transported from a tank and pumped to a nozzle which injects the tailings material into a vacuum chamber which is operated at lower than atmospheric pressure.

FIG. 2 is simplified schematic of a second embodiment according to the present invention, wherein chemical additives and gas additives are added to the tailings material before it reaches the nozzle. The gas can be used to improve the capability to spray the tailings material and disperse it in the air. Furthermore, the tailings material may be heated before it reaches the nozzle to accelerate the drying process.

FIG. 3 is sectional view of a nozzle that may be employed for embodiments according to the present invention, wherein the tailings material is flowed through an inner tube and gas is flowed through an annular space surrounding the tailings material port. The gas helps to disperse (or atomize) the tailings material into droplets. The gas can consist of any of air, carbon dioxide, nitrogen, methane, and combinations thereof.

Exemplary embodiments will now be described with reference to the accompanying drawings.

### DETAILED DESCRIPTION OF THE INVENTION

Throughout the following description, specific details are set forth in order to provide a more thorough understanding to persons skilled in the art. However, well known elements may not have been shown or described in detail to avoid unnecessarily obscuring the disclosure. The following description of examples of the invention is not intended to be exhaustive or to limit the invention to the precise form of any exemplary embodiment. Accordingly, the description and drawings are to be regarded in an illustrative, rather than a restrictive, sense.

The present description relates to treatment of tailings material to yield a dry or high solids content layered product comprising the solid components of tailings material. The resulting product can still contain water as long as the overall structure can be deposited in a terrestrial method for conventional reclamation.

At present, there are no commercially viable large-scale processes that exist to consolidate and dry tailings materials.

The present invention takes a new approach with respect to the following factors: additional forces (inertial forces imparted to the droplets when sprayed within the vacuum chamber) and thermodynamics of water at depressed pressure below that of atmospheric pressure.

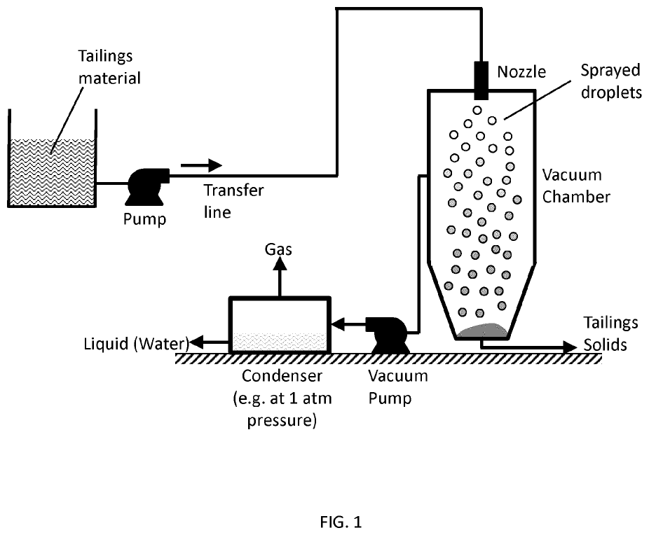

FIG. 1 illustrates a first embodiment of the present invention where tailings material is transported from a tank and pumped to the nozzle which injects the liquid tailings material as droplets into a vacuum chamber. The source of the tailings material can also be a tailings pond. The nozzle can be positioned at the top or near the top of the vacuum chamber.

Due to the low pressure within the vacuum chamber, the temperature at which the water boils (the saturation temperature) is lower than the normal boiling point (100° C. at atmospheric pressure). If the tailings are injected into the vacuum chamber at a sufficient temperature above the saturation temperature corresponding to the pressure in the vacuum chamber, then the water in the tailings material will start to boil and evaporate from the tailings material. For example, if the vacuum pressure in the chamber is equal to 10 kPa, the corresponding saturation temperature of water (the temperature at which it boils) is equal to 45.8° C. This implies that if the temperature of the tailings material entering the vacuum chamber is equal to or above 45.8° C., the water in the tailings material will boil and convert to vapour phase, thus drying the tailings material. If the chamber temperature is maintained equal to or above 45.8° C., then the conditions in the vacuum chamber will lead to boiling of the water from the tailings droplets. Prior to entering the vacuum chamber, the tailings material can be heated by using standard heaters or heat exchangers.

The droplets have greater surface area than a continuous bulk flow. This enables greater heat and mass transport and thus accelerates the vaporization of the water (and other volatiles) within the tailings leading to faster drying or partial drying of the tailings material.

The dry or partially dry tailings material that collects at the bottom of the vacuum chamber is removed from the chamber for subsequent processing or storage.

More than one nozzle can be used at the top of the vacuum chamber to form a greater number of droplets.

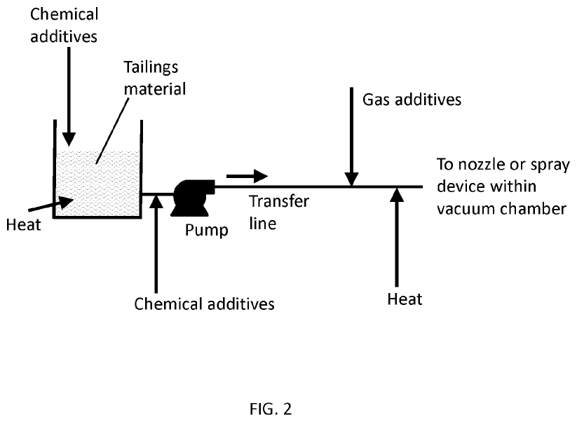

FIG. 2 illustrates a second embodiment of the present invention where chemical and gas additives are added to the tailings material before it reaches the nozzle in the vacuum chamber. The chemicals that can be added to the tailings material prior to the spraying device include mixtures of metal halide (for example, MXn, where M=aluminum, iron, sodium, potassium or copper, and X=fluoride, chloride, bromide or iodide) solutions with and without acid and/or base (to adjust pH as required). Other chemical additives that may be used include polymer or cellulose nanocrystals. A gas can be used to improve the capability to spray the tailings material and disperse it in the air. Examples of gases that can be used include air, nitrogen, carbon dioxide, flue gas from combustion (mixtures of nitrogen and carbon dioxide), and natural gas (methane). [069] Furthermore, the tailings material may be heated before it reaches the nozzle and/or vacuum chamber to accelerate the drying process. The temperature can be in the range from 10 to 99° C. and is preferably in the range from 20 to 60° C.

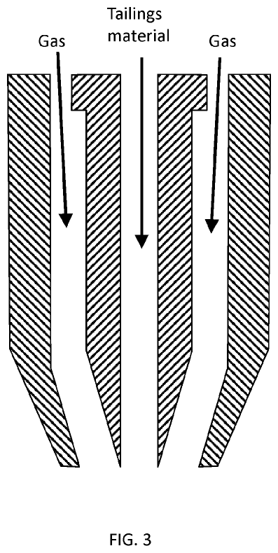

FIG. 3 provides a sectional view of an exemplary nozzle showing the inner tailings material tube and an annular gas injection zone surrounding the tailings material. The gas injection zone can also be from one or both sides of the tailings material port.

The spray device may consist of any appropriate form of nozzle or atomizer that yields droplets of tailings materials, in the judgment of the skilled person.

The foregoing is considered as illustrative only of the principles of the present invention. The scope of the claims should not be limited by the exemplary embodiments set forth in the foregoing, but should be given the broadest interpretation consistent with the specification as a whole.

1. A method for at least partially drying tailings materials from a mining operation, the tailings materials comprising water and solids, the method comprising the steps of:
a. generating droplets of the tailings materials;
b. introducing the droplets into a partial vacuum environment; and
c. allowing at least some of the water in the droplets to evaporate to produce a water vapour and a solids-dominant residual material.

2. The method of claim 1 wherein the step of generating droplets is achieved by spraying.

3. The method of claim 2 wherein the spraying is atomizing.

4. The method of claim 1 further comprising the step after step c. of extracting the water vapour from the partial vacuum environment and allowing the water vapour to condense into liquid water.

5. The method of claim 1 further comprising the step after step c. of extracting the solids-dominant residual material from the partial vacuum environment.

6. The method of claim 1 further comprising introducing at least one chemical additive to the tailings materials before the step of generating the droplets.

7. The method of claim 6 wherein the at least one chemical additive is selected from the group consisting of gases, salt solutions, acids, bases, polymers and flocculants.

8. The method of claim 1 further comprising the step of heating the tailings materials before the step of generating the droplets.

9. The method of claim 1 further comprising the step of heating the partial vacuum environment.

10. The method of claim 1 further comprising transporting the tailings materials from a storage pond prior to generating the droplets.

11. The method of claim 1 further comprising obtaining the tailings materials directly from an extraction process.

12. The method of claim 1 further comprising the step after step c. of allowing the solids-dominant residual material to impact a surface to release additional water.

13. The method of claim 4 further comprising the step after the step of condensing the water vapour into the liquid water of transporting the liquid water for re-use in the mining operation.

14. A system for at least partially drying tailings materials from a mining operation, the tailings materials comprising water and solids, the system comprising:
a tailings materials source; and
a vacuum chamber comprising an inlet for receiving the tailings materials from the tailings materials source, the vacuum chamber configured to allow at least some of the water in the tailings materials to evaporate to produce a water vapour and a solids-dominant residual material;
the vacuum chamber further comprising a vapour outlet for allowing the water vapour to leave the vacuum chamber; and
the vacuum chamber further comprising a solids outlet for allowing the solids-dominant residual material to leave the vacuum chamber.

15. The system of claim 14 further comprising a condenser in fluid communication with the vapour outlet for receiving the water vapour and condensing the water vapour into liquid water.

16. The system of claim 14 further comprising a chemical additives source and a chemical additives input line for introducing chemical additives into the tailings materials before the tailings materials enter the inlet of the vacuum chamber.

17. The system of claim 14 further comprising a heat applicator to heat the tailings materials before the tailings materials enter the inlet of the vacuum chamber.

18. The system of claim 14 further comprising a gas injector to inject gas into the tailings materials before the tailings materials enter the inlet of the vacuum chamber.

19. The system of claim 14 wherein the inlet comprises a nozzle configured to atomize the tailings materials to generate droplets.

20. The system of claim 14 wherein the vacuum chamber is a vacuum tower of a height sufficient to allow production of the water vapour and the solids-dominant residual material as the tailings materials pass downwardly through the vacuum tower.

21. The system of claim 14 wherein the solids outlet is in communication with a solids removal subsystem.

22. The system of claim 21 wherein the solids removal subsystem comprises an open-close gate or a screw conveyor for transporting the solids-dominant residual material away from the vacuum chamber.
